(19) United States
(12) Patent Application Publication
(10) Pub. No.: US 2012/0136804 A1
(43) Pub. Date: May 31, 2012

(54) Wealth Management System and Method

(75) Inventors: Raymond J. Lucia, SR., San Diego, CA (US); Raymond J. Lucia, JR., San Diego, CA (US)

(73) Assignee: Raymond J. Lucia, SR., San Diego, CA (US)

(21) Appl. No.: 12/957,211

(22) Filed: Nov. 30, 2010

(51) Int. Cl. G06Q 40/00

(52) U.S. Cl. 705/36 R

(57) ABSTRACT

Systems and methods for wealth management forecasting are provided. Financial and investment information can be collected from a client who wishes to implement a wealth management plan, and the performance of various scenarios can be forecast. Various scenarios can be developed that include dividing the investment portfolio of the client up into multiple buckets (referred to herein as “bucketizing” the portfolio) where each bucket has a different investment strategy that is part of an overall wealth management plan developed for the client. Each bucket can have different investment timelines and levels of risk associated with the investments in that portfolio. The forecasting process is completely automated, and the client can update various parameters to see how changes to the investment parameters can change the forecasted results of the wealth management plan, and the system can dynamically update the forecast to reflect the updated data.

### BACKGROUND

1. Field of the Invention

The present invention generally relates to financial planning systems and more particularly relates to online wealth management systems.

2. Related Art

Wealth management is a multi-disciplined advisory service that incorporates financial planning, investment portfolio management, and other financial services to manage an investment portfolio. Wealth management service providers can assist portfolio owners with issues related to an investment portfolio, such as managing the long term growth of the portfolio, tax planning, and risk management. Wealth management service can also provide estate planning advice to portfolio holders.

Wealth management planning for retirees and soon-to-be retirees is increasingly in demand for those who wish to enter their retirement years with greater confidence that their investments will last long enough to support them throughout their retirement years.

The shortcomings of conventional non-computerized wealth management techniques are that there are a number of factors that need to be considered when developing a financial plan. These factors include using taxable vs. non-taxable accounts, rates of return, inflation, required distributions, etc. Without the assistance of software and computerized techniques, any one of these factors could produce a financial plan that is materially different than the client's needs.

Therefore, what is needed is a system and method that overcomes these and other shortcomings of conventional wealth management techniques as described above.

### SUMMARY

Systems and methods for wealth management forecasting are provided. Financial and investment information can be collected from a client who wishes to implement a wealth management plan, and the performance of various scenarios can be forecast. Various scenarios can be developed that include dividing the investment portfolio of the client up into multiple buckets (referred to herein as “bucketizing” the portfolio) where each bucket has a different investment strategy that is part of an overall wealth management plan developed for the client. Each bucket can have different investment timelines and levels of risk associated with the investments in that portfolio. For example, each bucket can use different formulas and investment strategies based on the investment timelines and level of risk associated with the bucket. The forecasting process is completely automated, and the client can update various parameters to see how changes to the investment parameters can change the forecasted results of the wealth management plan. The system also helps to connect clients with financial advisors and can send a completed wealth management plan to a financial advisor to implement the plan using the assets in the clients portfolio.

According to an embodiment, a technical system for creating and forecasting the performance of a wealth management plan is provided. The system includes a non-transitory computer readable medium for storing computer executable programmed modules, and a processor communicatively coupled with the non-transitory computer readable medium for executing programmed modules stored therein. The system includes a data collection module stored in the non-transitory computer readable medium and configured to determine a set of buckets into which investments included in an investment portfolio are to be grouped, construct a questionnaire comprising a set of questions designed to collect financial information for a user for whom a wealth management plan is to be generated, and analyze responses to the questions included in the questionnaire to determine whether the user has provided enough information to generate a forecast of the performance of the wealth management plan. The system also includes a forecasting module stored in the non-transitory computer readable medium and configured to calculate a projected performance of investments associated with each bucket, and generate a wealth management plan report based on the projected performance of the investments associated with each bucket and other answers. The system also includes a user interface module stored in the non-transitory computer readable medium and configured to generate a bucket creation user interface to be displayed to the user on a user display device and designed to collect information from the user, said information used by the data collection module to identify the set of buckets, generate a questionnaire user interface designed to collect user responses to the set of questions selected by the data collection module, and generate a report interface for displaying wealth management plan report data to the user on a display of the user device.

According to another embodiment, a computer implemented method for creating and forecasting the performance of a wealth management plan is provided where one or more processors are programmed to perform the steps of the method. The method includes the steps of receiving a request to create a wealth management plan from a user device; identifying a set of buckets to include in the wealth management plan into which investments included in the wealth management plan will be allocated; generating a questionnaire to collect information from the user, generating a user interface to display the questionnaire to the user and collect user responses to the questions in the questionnaire, receiving responses to the questions from the user, forecasting the performance of investments associated with each bucket in the set of buckets based on the responses to the questions in the questionnaire, and generating a wealth management plan report based on the responses provided by the user.

According to another embodiment, a computer implemented method for creating and forecasting the performance of a hypothetical wealth management plan is provided where one or more processors are programmed to perform steps of the method. The method includes the steps of receiving a request from a financial advisor to generate a hypothetical wealth management plan for a client, the request including a set of financial information for the client; identifying a set of buckets to include in the wealth management plan into which investments included in the wealth management plan will be allocated; generating a hypothetical wealth management plan report for the client based on the financial information provided by the financial advisor; and sending the hypothetical wealth management plan report to the financial advisor.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of a financial planning and forecasting system according to an embodiment;

FIG. 2 is block diagram of the logical components of a server that can be used to implement the server illustrated in FIG. 1 according to an embodiment;

FIG. 3 is a flow diagram of a method for generating a wealth management plan according to an embodiment;

FIG. 4 is a flow diagram of a process for implementing a wealth management plan generated by the wealth management system according to an embodiment;

FIG. 5 is a flow diagram of a process for generating a questionnaire for collecting information for a wealth management plan according to an embodiment;

FIG. 6 is a flow diagram of a process for requesting a hypothetical wealth management plan for a client according to an embodiment;

FIG. 7 is a flow diagram of a process for generating a hypothetical wealth management plan for a client according to an embodiment.

FIGS. 8-17 are block diagrams of user interfaces for collecting and displaying information in the wealth management system according to an embodiment;

FIG. 18 is a block diagram of a computer system that can be used to implement the user devices of FIG. 1 of the server illustrated in FIGS. 1 and 2 according to an embodiment;

FIG. 19 is a block diagram of an exemplary wireless device that can be used to implement the user devices of FIG. 1 of the server illustrated in FIGS. 1 and 2 according to an embodiment.

### DETAILED DESCRIPTION

Certain embodiments as disclosed herein provide for creating and forecasting the performance of a wealth management plan. For example, one method as disclosed herein allows for a client or financial advisor to capture financial portfolio information for a client and to develop a comprehensive wealth management plan that can be used to forecast the performance of the plan. The plan can be customized to meet the investment goals of the client. For example, the plan can be customized to provide a client with a wealth management plan that balances providing income to the client during retirement while continuing to invest at least a portion of the portfolio to provide for continued growth of the portfolio even during retirement.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

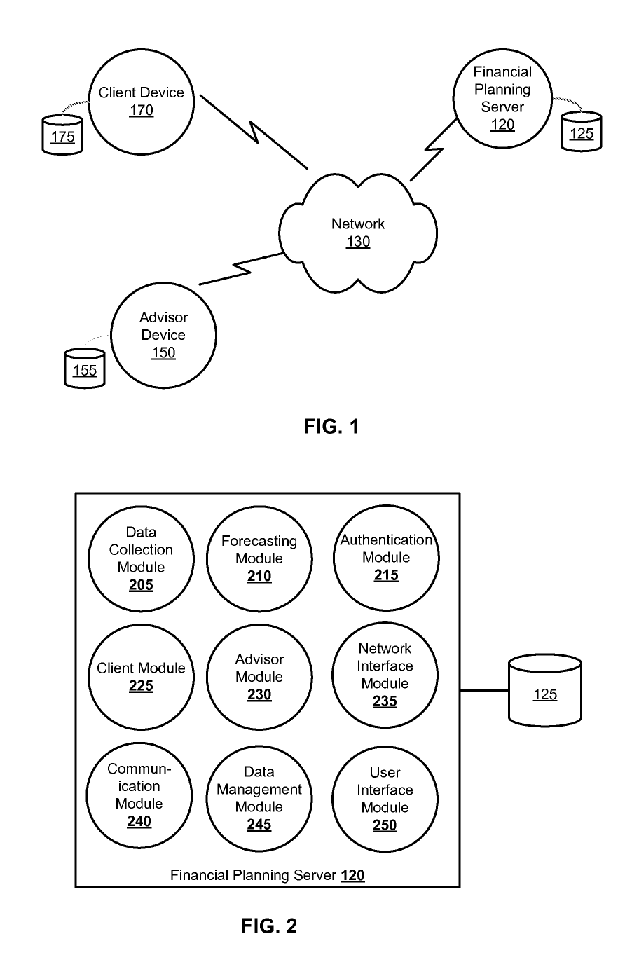

FIG. 1 is a block diagram of a financial planning and forecasting system (also referred to herein as a wealth management system) according to an embodiment. The system includes a financial planning server 120 that is in communication with a client device 170 and an advisor device 150, via a network 130. While the embodiment illustrated in FIG. 1 illustrates merely a single client device 170 and a single advisor device 150, other embodiments can include a plurality of client devices 170 and/or advisor devices 150. The client device 170 and the adviser device 150 can also be any sort of processor enabled computing device capable of communicating wired or wirelessly over the network 130, for example a personal computer, personal digital assistant (“PDA”), telephone, workstation, or the like.

In an embodiment, the server 120 includes a set of compiled or scripted software modules that can be executed on various programmable computer platforms. Server 120 communicates with the client device 170 and the advisor device 150 over the network 130. In one embodiment, server 120 is implemented as a set of software applications or modules stored in a computer-readable memory of a computer system. These software applications or modules, when executed by the processor of the computer system perform the various functions of the controller 120 described herein.

Network 130 can be a wired network, wireless network, or a combination of homogeneous or heterogeneous networks including both wired and wireless network segments. Network 130 can be a personal area network (“PAN”), local area network (“LAN”), or a wide area network (“WAN”), a private network, public network, or a combination of networks collectively comprising a global communications network such as the Internet. Network 130 can be an ad hoc network or a persistent network and can be fixed in location, mobile, or may comprise a combination of fixed and mobile components. Additionally, network 130 may carry communications corresponding to a single network protocol or to multiple network protocols such as 802.11, 802.15, 802.16, and TCP/IP, just to name a few.

According to an embodiment, server 120 can be configured to provide wealth management and forecasting services for a plurality of clients. The clients can interact with the financial planning system via a client device 170. In an embodiment, the financial planning system can communicate with a plurality of financial advisors. The financial advisors can interact with the financial planning system via the advisor device 150. In some embodiments, a client can access the financial planning system via the client device 170, and the server 120 can generate a set of user interfaces (e.g., web pages) that collect financial information from the client and investment preferences, and the server 120 can generate a forecast of the performance of the wealth management plan using the collected information. The server 120 can generate a summary report based on the information collected and provide the client with an interface for changing one or more of the parameters of the wealth management plan. If a client changes parameters of the wealth management plan, the server 120 can update the forecast using the updated parameters so that the client can see what the impact of various investments strategies can have on the client's overall portfolio. The user interface provided by the server 120 can also include an option to connect the client to a financial advisor that can implement the wealth management plan designed by the client using the user interface provided by server 120. Server 120 can select an advisor from a plurality of financial advisor information stored in the data store 125, and send the wealth management plan information data entered by the user and the forecast information to the advisor device 150 of the selected advisor. According to some embodiments, the server 120 can provide a user interface that displays a list of advisors located near the client and the client can select an advisor to implement the wealth management plan. The data store 125 can be used to store financial and other data entered by a clients, wealth management forecast data generated from the data provided by the clients, and authentication information for the clients (e.g., login credentials for accessing the financial data and forecast information stored on the server).

Client device 170 can include a data store 175, and the advisor device 150 can include a data store 150. The data stores can be used to store financial planning and wealth management data and forecast reports generated by the financial planning server 120.

FIG. 2 is block diagram of the logical components of a server that can be used to implement the server 120 illustrated in FIG. 1 according to an embodiment.

Data collection module 205 is configured to receive bucket information from a user that defines the buckets to be used in a wealth management plan. The data collection module 205 can receive this information via the user interface module 250. The user interface module 250 can generate a bucket creation user interface that allows a user to define the buckets to be used in the wealth management plan. The user interface can allow the user to add buckets, delete buckets, or edit the attributes of buckets. In an embodiment, each bucket can have different levels of risk associated with the investments included in that bucket. Each bucket can also have different levels of liquidity of the investment assets, and can also have different investment goals and timelines associated with them. For example, a wealth management plan might divide investments up into three bucket: (1) a first bucket that includes low risk investments that provide current steady stream of income, (2) a second bucket that includes investments that provide a slightly higher level of risk but a greater level of return and should provide a moderate rate of return in the near term, and (3) a third bucket that includes longer term investments that promise a higher rate of return but also have the highest risk related to them relative to the investments included in the other two buckets.

Data collection module 205 is configured to communicate to determine which questions should be included on questionnaires to be presented to a user to collect financial information to be used in generating a wealth management plan for a client. The data collection module 205 is also configured to correlate the information provided by the user with the financial information required for the forecasting model being used to determine whether the user has provided sufficient information to forecast the performance of an investment portfolio allocated according to the wealth management plan. For example, the data store 125 can include a plurality of questions related to the investment goals of the client and for gathering the type of information related to various investments to be included in the portfolio. The data collection module 205 can provide the questionnaire information to the user interface module 250, which can generate a questionnaire user interface, such as a set of web pages, for displaying the questionnaire to the user and for collecting the user's responses. The user interface module 250 can provide the user's responses to the questions to the data collection module 205 to verify that the data input by the user, and the data collection module 205 can store the data entered by the user in the data store 125 using the data management module 245. The data collection module 205 can also be configured to access responses to questions that the client has already provided that are stored in the data store 125 and provide those and the questions to the user interface module 250 so that the user interface module 250 can display on the questionnaire user interface the portions of the questionnaire that the user already filled out and the user can continue working on the questionnaire. According to an embodiment, the data collection module 205 can present the questionnaire to the user using a “wizard” interface that walks the user through the questionnaire, presenting the questions to the user, and collecting the user responses.

According to an embodiment, the investment goals questionnaire can be used to customize the wealth management plan to the specific needs of the client. For example, the questionnaire can be used to determine whether the base the wealth management plan on based on a withdrawal rate (a percentage of the portfolio value at retirement) or based on total income from all sources, such as social security, pensions, and rental income. The wealth management plan can take into account the total income needs of the client based on these additional sources of income, and the overall investment strategy can be configured to take this additional income into account. The system can then select a set of buckets that into which the client's portfolio can be divided in order to achieve the client's retirement goals.

Forecasting module 210 is configured to forecast the performance of an investment portfolio of a wealth management plan. The forecasts include projected performance of various investments scenarios based on the data provided by clients and a selected investment strategy. According to an embodiment, the forecasting module 210 is configured to receive a set of bucket definitions used in a wealth management plan from the data collection module 205 and calculate a projected performance of the investments associated with each bucket. The forecasting module 210 is also configured to generate a wealth management plan report that includes a detailed breakdown of the projected performance of the investment portfolio if the plan is implemented according to the parameters used to generate the forecast. In an embodiment, the wealth management plan report breaks down the performance information on a bucket by bucket basis so that the client can see how each bucket is projected to perform. The client can use this information to determine whether to make changes to the attributes of one or more of the buckets to see how these changes might alter the performance of the plan. In an embodiment, the forecasting module 210 can provide the wealth management plan report data to the user interface module 250 and the user interface module 250 can display the report data to the user on a report user interface.

User authentication module 215 can be configured to operate in conjunction with the client module 225 and the advisor module 230 to control access to client and/or advisor related information by requiring that clients and advisors provide credentials to verify their identities. For example, the user authentication module 215 can be configured to require advisors and clients to enter a username and password or username and personal identification number (PIN) associated with the client or advisor in order to access the system. The user authentication module 215 can also be configured to use encryption keys associated with clients and advisors to encrypt communications between the client device 170 and the server 120 and the between the advisor device 150 and the server 120 to ensure that those attempting to access the system are who they are purported to be and that unauthorized third parties cannot easily intercept sensitive financial information being transmitted across the network 130.

In an embodiment, the user interface module can provide login credentials received from a user and the user authentication module 215 can authenticate the credentials by accessing the data store 125 to retrieve user information associated with the username provided and compare the password or pin provided by the user to the password stored in the data store 125. In an alternative embodiment, usernames and passwords can be stored in a user authentication database that can be accessed by the user authentication module 215. In an embodiment, the user authentication module can access the data store 125 or other data stores via the data management module 250.

Client module 225 can be configured to operate with the user interface module to provide user interfaces, such as web pages, that allow a client to log into the wealth management system, to enter financial data and other data into the system, and to display forecast results based on the information entered by the client. The client module can be configured to interface with the communication module 225 to allow a client user to generate communications to a selected financial advisor and to request that a wealth management plan and financial information associated with the plan be sent to the selected financial advisor so that the financial advisor can implement the plan.

Advisor module 230 can be configured to operate with the user interface module to provide user interfaces, such as web pages, that allow a financial advisor to log into the wealth management system, to enter financial data and other data into the system for a client or view financial information entered by a client, and to display forecast results based on the information financial information entered by the client and/or the financial advisor. The advisor module 230 can be configured to interface with the communication module 225 to allow a financial advisor user to generate communications to a client.

Network interface module 235 provides an interface for receiving data from network 130 and for sending data across network 130. Network interface module 235 can be configured to receive data from network 130 and to provide the data to one or more of the other modules of the server 120. The network interface module 235 can be configured to format the data received from the network 130 into a format that is expected by a module of server 120 that is to receive the data. In an embodiment, network interface module 235 can be configured to format data received from other modules of the server 120 for transmission across the network 130.

Communication module 240 is configured to provide an interface for advisors or clients to generate communications between one another. In some embodiments, a client can generate an email to a selected financial advisor, and the selected financial advisor can generate communications to the client. The communication module 240 can be configured to operate with the user interface module 260 and the client module and the user interface module 260 can provide a user interface that allows a client to draft a communication to a selected financial advisor or allow the selected financial advisor to draft a communication to the client. In an embodiment, the communication can comprise emails, text messages, instant messages, and/or other types of communications. In yet other embodiments, the communication module 240 can generate a facsimile based on communication content input by a client or advisor. In yet other embodiments, the communications module 240 can generate a communication that is formatted to be sent to a printer to generate a physical copy that can be sent via the postal service.

Data management module 250 is configured to provide an interface to server 120 for retrieving data from and storing data to data stores, such as data store 125. The data management module 250 can receive requests to access data from or store data to data store 125 or other data stores from the other modules of server 120. The data management module 250 can format the requests into a format that can be understood by the databases or data stores. For example, if data store 125 is a relational database, data management module 250 can convert a request received from a module of server 120 to a query, such as a Structured Query Language (“SQL”) query. The data management module 250 can also receive data from the data store 125 or other data store and convert the data to a format expected by the module requesting the data.

User interface module 260 can be configured to provide a user interface, such as a web page or web pages, for the client device 150 and advisor device 170 to interact with the server 120 to use the systems and methods disclosed herein. For example, in an embodiment, the user interface module 225 can be configured to generate web pages that can be displayed in a browser program being executed on client device 150 or advisor device 170. The user interface module 260 can be configured to generate the user interface screens that enable a client or advisor user to enter financial data and generate forecasts. The user interface module 260 can communicate with the data management module 250 to request data to be displayed to a user of a client device 170 or advisor device 150 and to store data entered by users. The user interface module 260 can also provide a login user interface in which a user can enter login credentials to be authenticated by the server 120 in order to access the wealth management system.

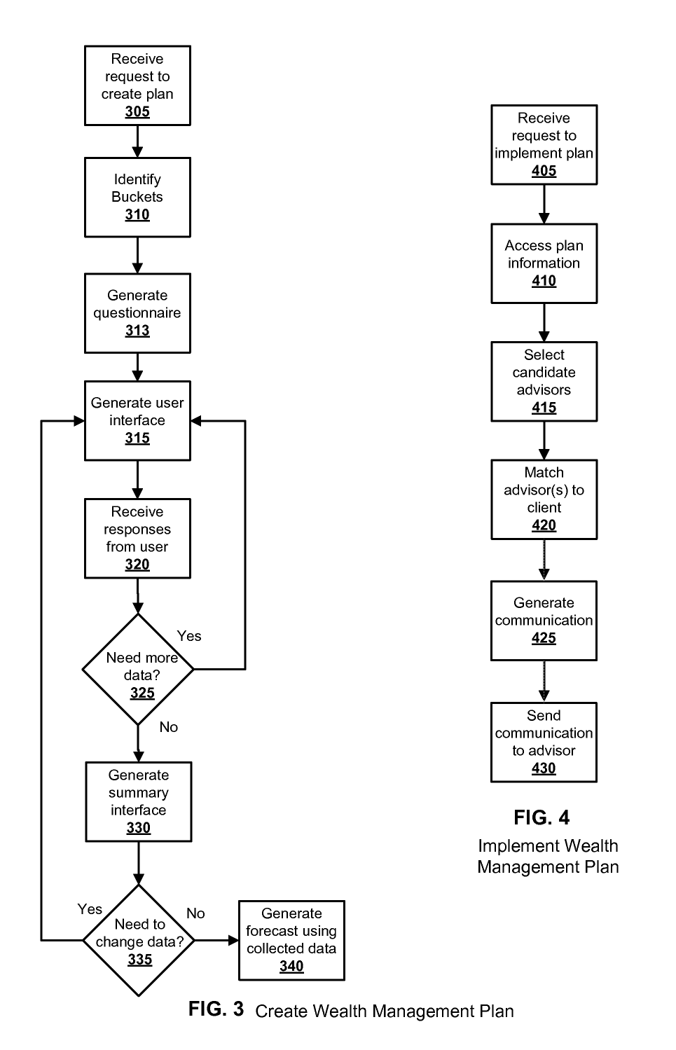

FIG. 3 is a flow diagram of a process for generating a wealth management plan according to an embodiment. According to an embodiment, the method illustrated in FIG. 3 can be implemented by the wealth management server 120.

The server 120 can receive a request to create a wealth management plan from a user device (step 305). According to some embodiments, the user device can be a client device and the user can be client for whom the wealth management plan is to be created. In other embodiments, the user device can be an advisor device and the user can be a financial advisor who provides financial advice to the client and is setting up a wealth management plan on behalf of the client. In an embodiment, the user interface module 250 can receive a request to create a wealth management plan from a client at a client device who has selected an option to create a new wealth management plan from a web page provided by the server 120. In another embodiment, the user interface module 250 can receive a request to create a wealth management plan from a financial advisor at an advisor device who has selected an option to create a new wealth management plan on behalf of the client from a web page provided by the server 120.

A set of buckets into which the client's investment portfolio is to be divided can then be identified (step 310). In one embodiment, the data collection module 205 can select a default set of buckets that can be used for most clients. In another embodiment, the data collection module 205 can select a default set of buckets based on investment goal information provided by the client. For example, the data collection module 205 could instruct the user interface module 250 to display a set of investment goal questions to the user that can be used to assess the investment goals of the user. The user interface module 250 can collect the user's responses to these questions and provide the responses to the data collection module 205 for analysis. The data collection module 205 can then analyze these responses to select a set of buckets that may be able to meet the investment goals of the client. According to an embodiment, data collection module 205 can assign a score to each of the user's responses to the investment goal questions and match the score to one of a plurality of predefined bucket configurations that are stored in the data store 125.

In an embodiment, the user interface module 250 can provide a user interface that displays the default bucket information to the client or advisor user, and allows the user to add additional buckets, edit the attributes of buckets, or delete buckets from the plan. The user can then submit the desired bucket configuration to the client device.

The data collection module 205 can then generate a questionnaire that includes a set of questions designed to collect information from the user (step 313). The data collection module 205 can identify the information that needs to be collected from the user to forecast the performance of a wealth management plan using the buckets that were identified. As described above, the data collection module 205 can access the data store 125 to select questions associated with the types of investments that can be included in each bucket, and any relevant client data already stored in the data store 125. The questionnaire can include questions to collect information for each of the buckets. Some of the information can be shared between buckets. As a result, the same questions could appear on multiple screens of the questionnaire, but user interface module 250 can populate any the answers provided to the same question on other screens so that the user does not have to reenter the same information multiple times.

The data collection module 205 can then provide the questions for the questionnaire and the client data to the user interface module 250, which can generate a set of screens (e.g., web pages) that can display the questions to the user and can collect the user's responses to these questions (step 320). According to an embodiment, the user responses collected by the user interface module 250 can be stored in the data store 125 or another persistent memory by the data management module 245. According to an embodiment, the user interface generated by the user interface module 205 can include embedded video and/or links to video content that comprises a short video clip that explains the purpose of the screen and what the data means that the screen is collecting. The video content can also provide general background information about different types of investment vehicles, such as real estate investment trusts and annuities, which could be incorporated into the wealth management plan.

The user interface module can receive the responses entered by the user (step 325). In an embodiment, the screens generated by the user interface module comprise a set of web pages that are displayed on browser on either the client device 170 or the advisor device 150. The user can enter data into fields included on the web page and click a button or link on the page to submit the data to the server 120. The server 120 can parse the information entered on the web page by the user and provide the information to the user interface module 120, which can format the information and provide it to the data collection module 205. For example, the user interface module 250 can format monetary data received into a proper decimal format, remove leading or trailing white space from responses, and validate the inputs to ensure that the data is in an expected format. For example, each field on the screen can have an input type associated with the field and the user interface module can check to see if the format of the data entered into that field matches an expected type. If the data entered does not match an expected type, the user interface module 250 can generate an error message that can be displayed to the user and cause the screen and the user entered data to be redisplayed to the user for correction. According to an embodiment, any calculations, graphs, totals, displayed on each screen can be updated dynamically as the user enters data into the fields on the screen.

A determination is made whether any more data is needed (step 325). In an embodiment, the data collection module 205 can analyze the information provided by the user to determine whether the information is complete. For example, if the failed to fill in one or more fields that capture information that is required to generate a forecast, the system can prompt the user to enter the missing data. If more data is needed from the user, the method can return to step 520 where a user interface can be generated to collect the remaining information required from the user.

Otherwise, if all of the data needed to generate the wealth management plan has been received, the user interface module 250 can generate a summary interface to display a summary of the information entered to the user (step 330). The summary interface allows the user to review the data that was entered and identify any changes or corrections to the data that the user might wish to make before the plan is generated.

If the user wishes to make changes to the data entered, the method can return to step 315, where the user can update the information entered. Otherwise, the method can continue with step 340 where the performance of the wealth management plan based on the information provided by the user can be forecast (step 345). In an embodiment, the forecasting module 210 can forecast the performance of the wealth management plan using the investment data associated with each of the buckets AND answer to the questions that the user provided (e.g. risk tolerance, age, etc.). The forecasted performance of the wealth management plan can be displayed to the user via a web page or series of web pages displayed on the screen of the client device 170 or the advisor device 150. The user interface can also include options for printing the report, saving an electronic copy of the report, or sending an electronic copy of the report to a financial advisor (if the user is a client) or to a client (if the user is a financial advisor). The user interface can also include options for saving the report into different file formats.

According to an embodiment, each bucket includes a common set of characteristics: (1) a beginning value, (2) a rate of return, (3) earnings, (4) savings, (5) withdrawals, and (6) an ending value. The beginning value represents the initial value of the investment or investments included in that bucket. The rate of return represents the return on the original investment (the amount forecast to be gained on the original investment) divided by the original investment amount. The earnings represent beginning amount of the investment multiplied by the rate of return. Savings represents additional investments that have been contributed to the initial investment. Withdrawals represent a portion of the investment that has been taken from the investments within the bucket. For example, the bucket may be configured such that the forecast includes paying the client $1000 per month from the investment assets. The ending value equals earnings plus savings minus withdrawals. The performance of each bucket can be determined based on the timing of addition or withdrawals, the rate of return, and other factors unique to each client situation.

FIG. 4 is a flow diagram of a process for implementing a wealth management plan generated by the wealth management system according to an embodiment. In an embodiment, a client user that generates a wealth management plan using the financial planning server 120 can request that the server 120 send the plan to a financial advisor to implement the plan. According to an embodiment, the client user 120 can send the plan to their personal financial advisor to implement the wealth management plan using the client's resources. The server 120 can also be configured to match a client with a financial advisor and to send the wealth management plan and the client's contact information to the financial advisor so that the financial advisor can contact the client to obtain access to the client's investment portfolio in order to implement the plan.

The server 120 receives request to implement plan from client (step 405). As described above, the user interface module 250 can display to the user a summary of the wealth management plan that has been generated using the system. This user interface can include a button, a link, or other user interface element that the user can activate to indicate that the user would like to implement the wealth management plan generated using the system.

The communication module 240 can access the wealth management plan information stored in the data store 125 (step 410), and can optionally select a set of candidate financial advisors that might be a good match for the client if the client has not already selected a financial advisor (step 415). According to an embodiment, the user can be prompted whether the user has already got a financial advisor and whether the user would like to implement the plan using that financial advisor. If the client indicates that the client would like to use their already selected financial advisor, the user interface module 250 can generate a user interface to collect the contact information for the financial advisor from the user and store the information collected in the data store 125.

If the user has not already selected a financial advisor, the system can match the client to a financial advisor from the list of candidate financial advisors selected from financial advisors whose contract information is stored in an advisor data store of the server 120 (step 420). In an embodiment, the advisor data store can be stored in the data store 125 of the server 120. Various matching criteria can be used to match a financial advisor to the client. For example, a financial advisor located in a geographical area near the client can be selected, or a financial advisor having expertise in a particular type of investments can be selected.

A communication that provides contact information for the client and explaining the wealth management plan that the client would like to implement can then be generated (step 425). In some embodiments, an electronic communication, such as an email, can be generated to the financial advisor that includes the wealth management plan and the client's contact information so that the financial advisor can contact the client to obtain access to the client's investment portfolio in order to implement the plan. In other embodiments, a copy of the wealth management plan can be submitted to the financial advisor using other methods, such as facsimile or postal mail.

The wealth management plan report generated by the server 120 and the communication to the financial advisor can then be sent to the selected financial advisor (step 430). In embodiments where an electronic copy is sent to the financial advisor, the server 120 can send the communication over the network 130 to the advisor device 150. In other embodiments, the server 120 can fax or email the communication and the wealth management plan report. The financial advisor can use the information in the communication to contact the client in order to obtain access to the client's investment portfolio and to begin implement the wealth management plan. Implementing the plan can include investing the client's funds in various investment vehicles on behalf of the client. This process can include divesting the client of existing investment in order to fund the investments into the various investments recommended in the wealth management plan report that was generated for the client.

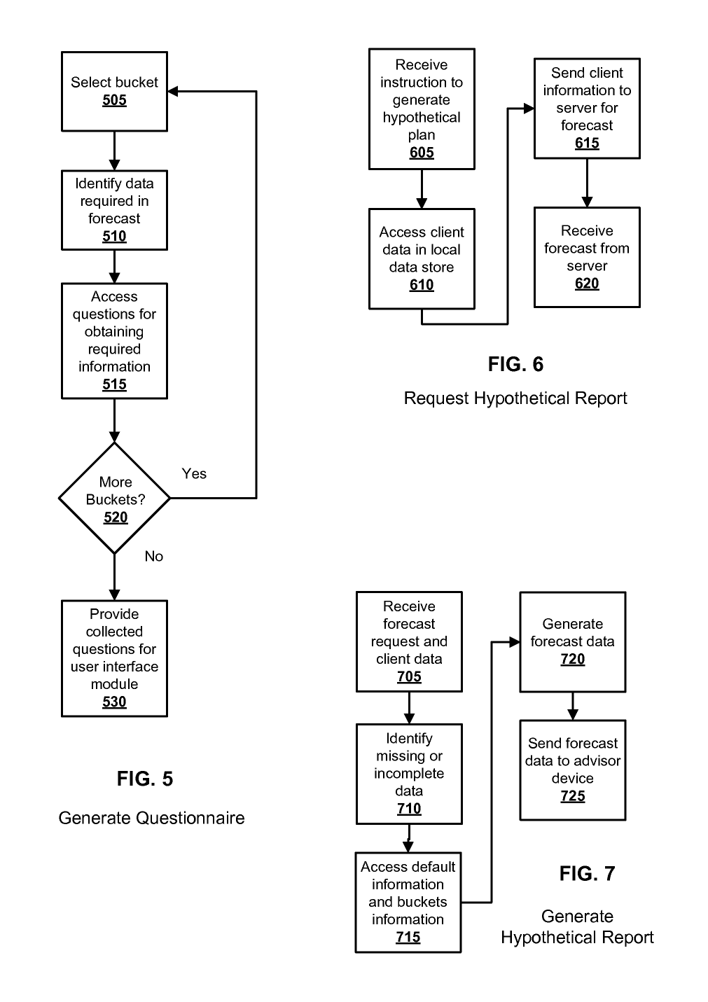

FIG. 5 is a flow diagram of a process for generating a questionnaire for collecting information for a wealth management plan according to an embodiment. The method illustrated in FIG. 5 can be implemented by the data collection module 205, can be used to implement step 313 of the method illustrated in FIG. 3.

A bucket is selected from the plurality of buckets that were selected for inclusion in the wealth management plan (step 505). As described above, the number of buckets of that can included in a wealth management plan can be configured by a user so the number of buckets can vary from plan to plan. In an embodiment, the buckets for the wealth management plan can be selected in step 505 of the method illustrated in FIG. 5.

The data collection module 205 can identify information required to forecast for bucket (step 510) based on the attributes of the bucket. For example, the bucket might be associated with high risk long term investments. Therefore, the questions related to stocks might be selected, because a long term higher risk bucket looking for a higher rate of return is likely to include stocks. The types of investments included in each bucket may overlap somewhat based on the types of returns and the level of risk and the timeline associated with each bucket.

The data collection module 205 can then access questions for obtaining required information from the data store 125 (step 515). The data collection module 205 can also access any financial or other data that the client may have already provided and place that

A determination is made whether questions for additional buckets need to be collected (step 520). If more buckets remain to be processed, the method returns to step 505 where a next bucket is selected. If there are no more buckets to be processed, the information collected by the data collection module 205 is sent to the user interface module to generate a user interface for presenting the questions to the user and for collecting user responses.

FIG. 6 is a flow diagram of a process for requesting a hypothetical wealth management plan for a client according to an embodiment. The method illustrated in FIG. 6 can be used to mine account information from existing contents or clients of a financial advisor and to generate a hypothetical wealth management strategy for the clients or contacts.

The method illustrated in FIG. 6 can be implemented in the advisor device 150 according to an embodiment. In some embodiments, financial advisor can maintain a client contact database of present or potential clients. This database can be stored in the data store 155 or in another data store accessible by the advisor device 150. The database of client contact information may include actual or estimated financial data for the client. For example, the financial advisor may have information regarding an investment or set of investments that the financial advisor manages for the client. The financial advisor can use the information that the financial advisor has for the client to request that the wealth management system generate a hypothetical wealth management plan that illustrates how the client contact could benefit from creating a wealth management plan. The financial advisor can use the hypothetical wealth management plan to advertise the financial advisor's services to the client content and to illustrate how the financial advisor could help the client contact implement such a plan.

The client device 150 can receive a request to generate a hypothetical wealth management plan for a client contact from the financial advisor's list of client contacts (step 605). According to an embodiment, the client device 150 can include a user interface that is configured to allow the financial advisor to view a list of client contacts, and select a client contact from the list of client contacts for which a hypothetical wealth management plan is to be generated.

The advisor device 150 can access the client contact data stored in the data store 155 or in another data store accessible by the advisor device 150 (step 610) and transmit a request the financial planning server 120 to generate a hypothetical wealth management plan for the client contact (step 615). The advisor device 150 can then receive hypothetical wealth management plan data from the server 120 based on the client information provided by the client device 150. The financial advisor can then send the hypothetical wealth management plan data to the client contact as a marketing tool for advertising potential returns that the client might experience for their investment portfolio by implementing such a wealth management plan with the financial advisor. For example, in an embodiment, the server 120 can calculate hypothetical wealth management plan data from a set of hypothetical asset data that comprises a mix of assets that a potential client might have. The hypothetical asset data could be modified by the financial advisor to include real or estimated data tailored for a particular client based on information that the financial advisor might have for the client. In some embodiments, the system might include one or more stock hypothetical wealth management plans from which a financial advisor could choose one or more plans to be simulated for a potential client.

FIG. 7 is a flow diagram of a process for generating a hypothetical wealth management plan for a client according to an embodiment. The method in FIG. 7 corresponds to the method illustrated in FIG. 6, and the method illustrated in FIG. 7 can be implemented in the financial management server 120 according to an embodiment. The financial planning server 120 can use the information for the client provided by the advisor device 150 to generate a hypothetical wealth management plan for the client. In the event that the information required to generate the wealth management plan is incomplete, the server 120 can use default portfolio information to generate a hypothetical wealth management plan that illustrates how such a plan can help the client realize the client's investment goals even without specific financial information that fully reflects the investment portfolio of the client.

The server 120 can receive a request to generate a hypothetical wealth management report for a client from the advisor device 150 via the advisor module 230. The request can include client identification information that identifies the client and client financial information. The client financial information can be actual financial information that the financial advisor had for the client or may be estimated

According to one embodiment, advisor device 150 can provide a user interface that enables the financial advisor to view client contact information and to select a client for whom the financial advisor would like to generate a hypothetical wealth management plan. In such embodiments, the advisors device 150 can send a message to the server 120 via the network 130 requesting that the server 120 generate a hypothetical wealth management plan for the client. In an alternative embodiment, the server 120 can generate a user interface, such as a set of web pages, for a financial advisor via the user interface module 250 that a financial advisor can access by logging into the system. The authentication module 215 can be used to authenticate the financial advisor before the financial advisor can access the system. The user interface provided by the user interface module 250 of the server 120 can include a screen that allows the user to generate a request to the server 120 to generate a hypothetical wealth management plan for the client.

The server 120 receives the forecast request and client data from advisor device 150 (step 705). According to an embodiment, the information can be received via the network 130 from the advisor device 150. The forecasting module 210 can analyze the information received to identify missing or incomplete data that is required to forecast the performance of an investment portfolio (step 710). If there is information that is missing or incomplete, the forecasting module 210 can access default information from a forecasting data store stored in the data store 125 via the data management module 245 (step 715). The default information can include sample financial information representing a sample investment portfolio. The portfolio can be diversified into various types of investments, and a typical mix of investment types can be selected based on client demographics. The number of buckets used in the plan and the attributes of each of these buckets can also be selected by the forecasting module 210 based on typical plans that have been implemented for clients having similar demographics.

According to an embodiment the level of accuracy of the model used to create the hypothetical wealth management plan for the client can be greatly increased if the specificity and accuracy of the information regarding the current investment portfolio for the client is increased. However, even a hypothetical wealth management plan can be generated using default information from the server if necessary. This allows the financial advisor to demonstrate how the client could benefit from implementing such a plan with the advisor even though the information is not necessarily representative of the client's exact financial situation.

Once the forecasting module 210 has collected the information that is required to forecast the performance of the hypothetical portfolio, the forecasting module 210 generates a hypothetical wealth management plan by modeling the anticipated results of investing according to the client information and the hypothetical information collected (step 720). The forecasting module 210 can then send the forecast data to advisor device (step 725) so that the financial advisor can review the hypothetical wealth management plan and can send the plan to the client. In other embodiments, the financial advisor can adjust the default values and resubmit the plan to the server 120 to have the model recalculated based on the parameters changed by the financial advisor.

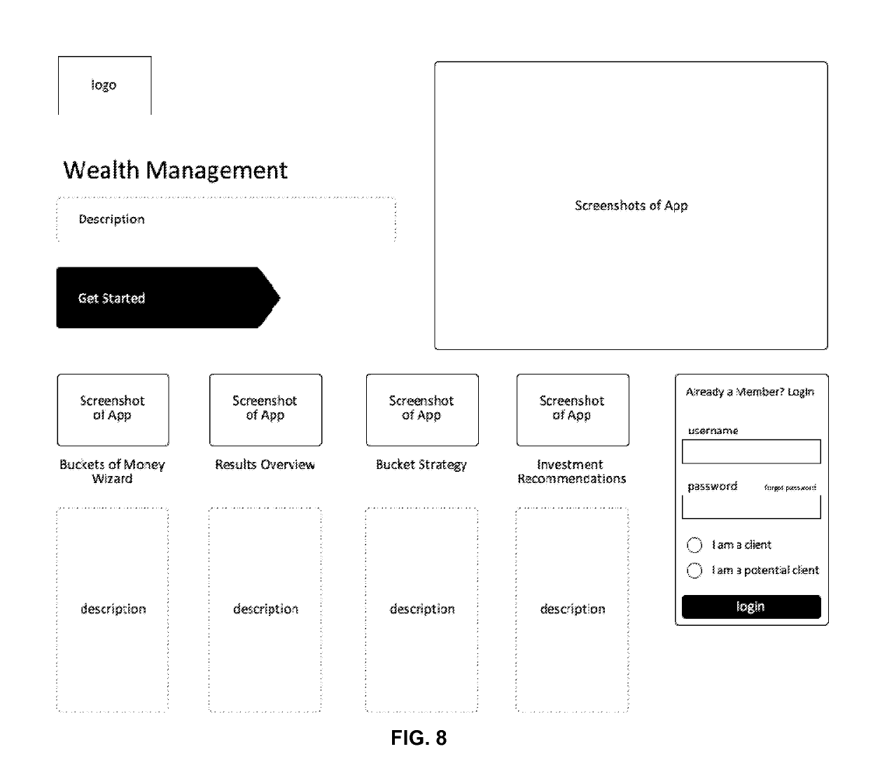

FIGS. 8-16 are block diagrams of user interfaces for collecting and displaying information that can be generated by the user interface module 250 according to an embodiment.

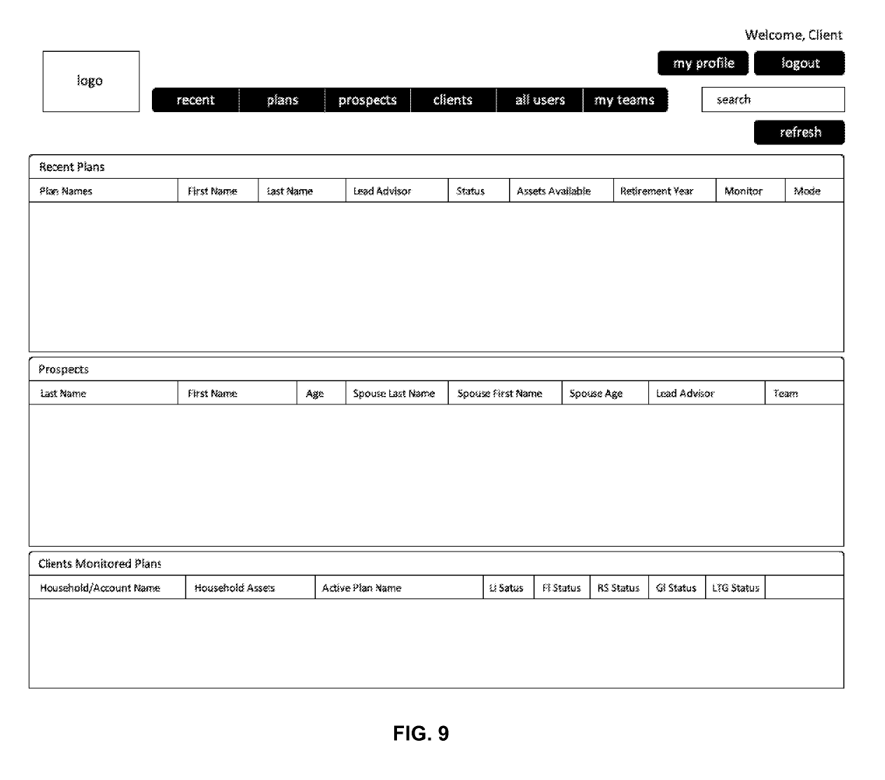

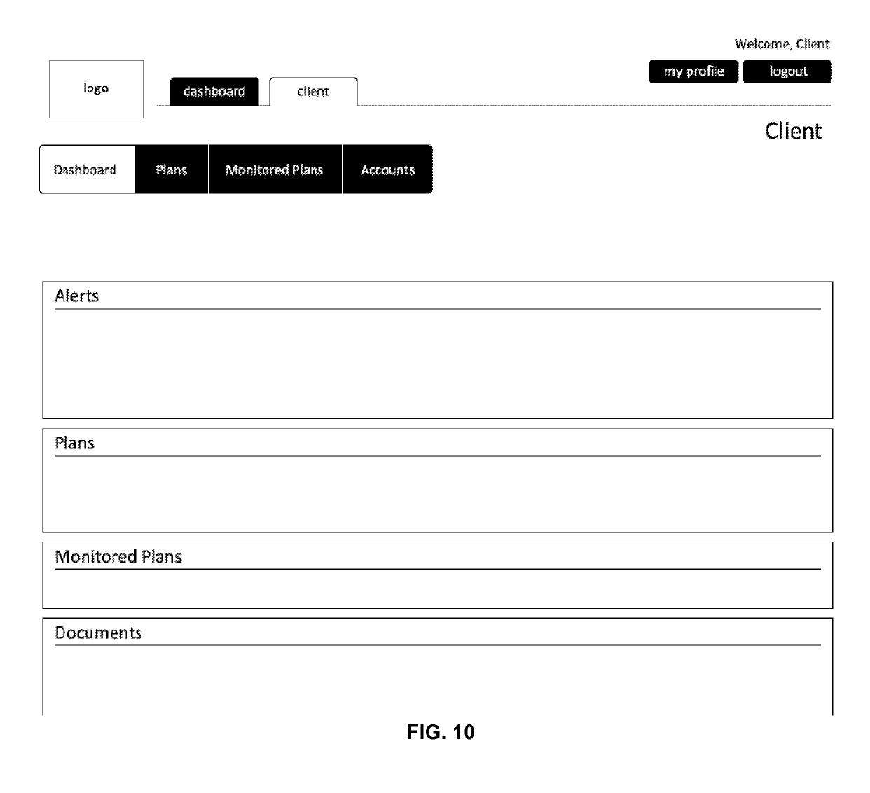

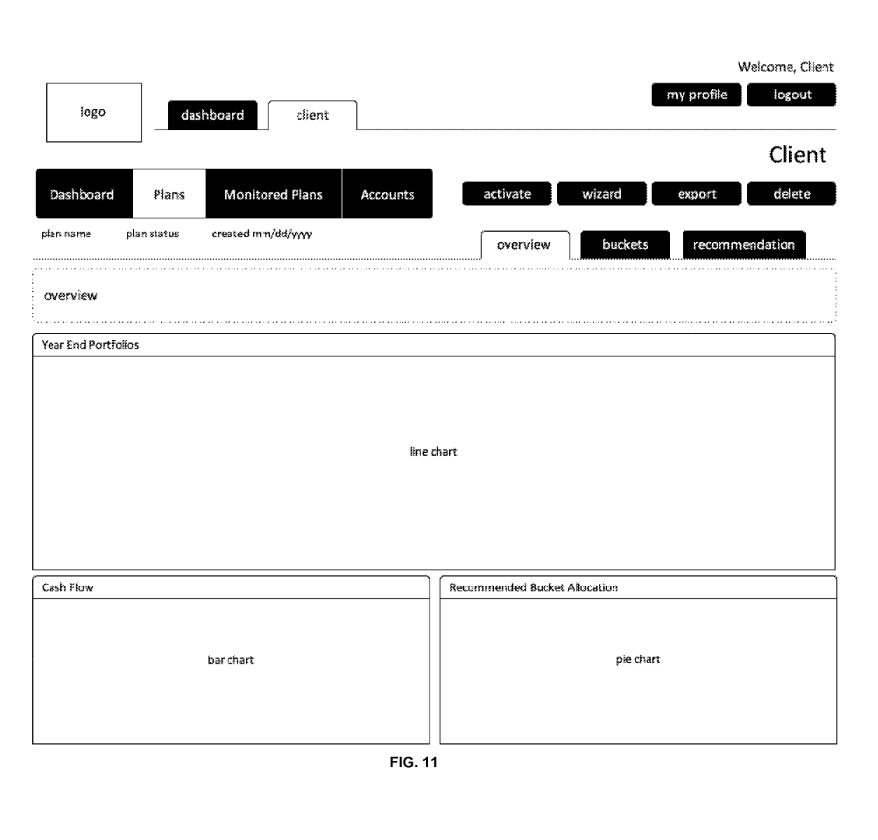

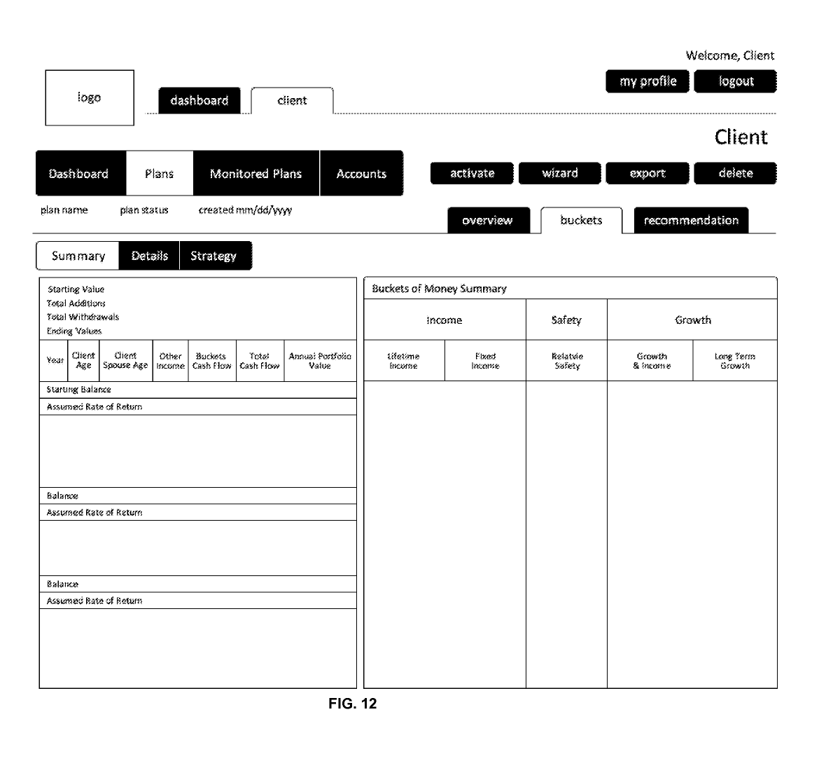

FIG. 8 illustrates a login screen that can be used for clients and/or financial advisors to log into the system. FIG. 9 is an example of an advisor dashboard interface screen that can be displayed to an advisor user after the advisor logs into the system via the login screen illustrated in FIG. 8. The advisor dashboard allows the advisor to access and/or modify client and prospect information, as well as access and/or modify wealth management plan information. FIG. 10 is an example of a client dashboard interface screen that can be displayed to a client user after the client logs into the system via the login screen illustrated in FIG. 8. As can been in FIG. 10 the client dashboard includes plan and account information that is related to the client that has logged into the wealth management system in contrast the advisor dashboard interface that allows an advisor to access information for multiple clients and/or prospective clients. FIG. 11 is a plan user interface that allows a client to view wealth management plans associated with the client. The plan user interface allows the client to view year-end portfolio information, cash flow information, and recommended bucket allocations for a wealth management plan. FIG. 12 is a buckets user interface that illustrates the summary of a wealth management plan for a client, including each of the buckets, and the forecasted performance of the plan over the life of the plan. The user interface includes various actionable areas/buttons that allow a user to print a hardcopy of the plan, save an electronic copy of the wealth management plan, and to contact a financial advisor to implement the wealth management plan according to an embodiment. According to an embodiment, the buckets user interface can include an “activate” actionable area/button to implement the wealth management plan, if activated by a user, can cause the server 120 to execute the method illustrated in FIG. 4.

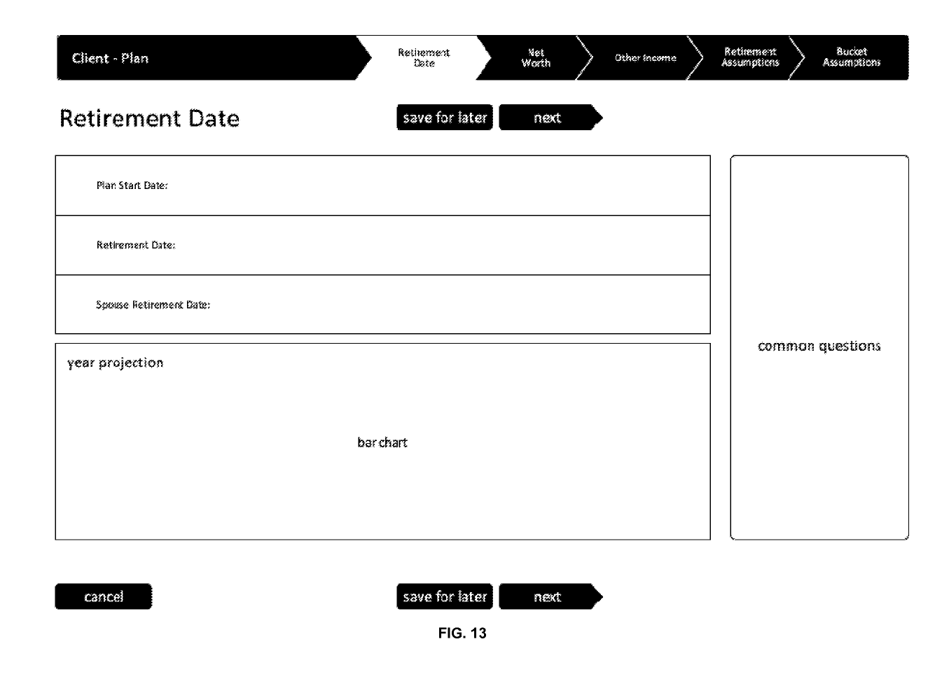

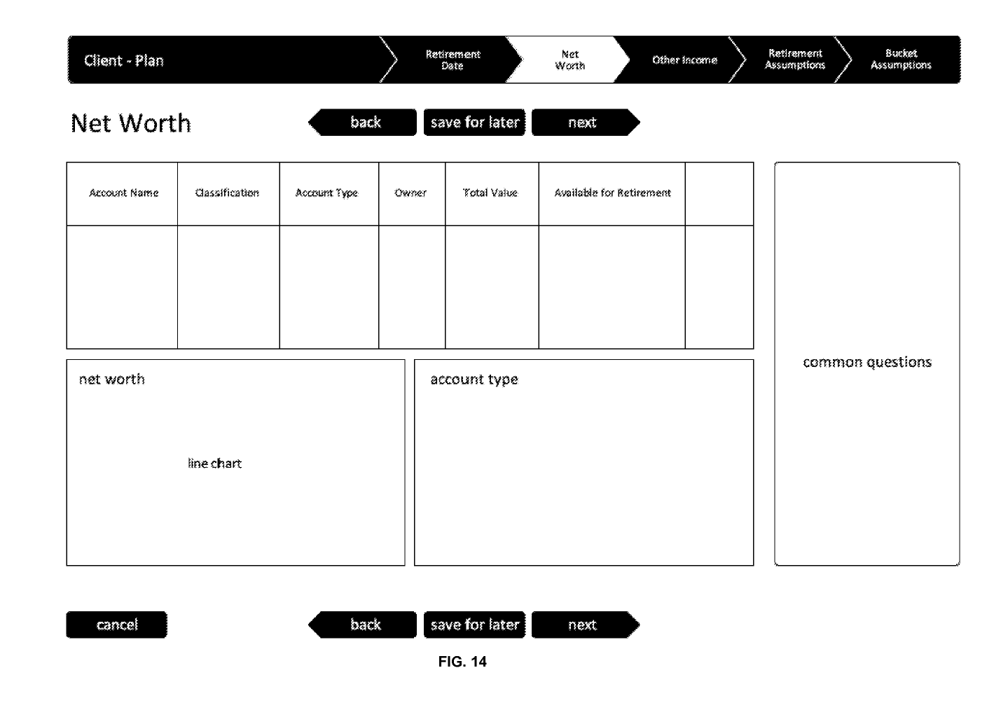

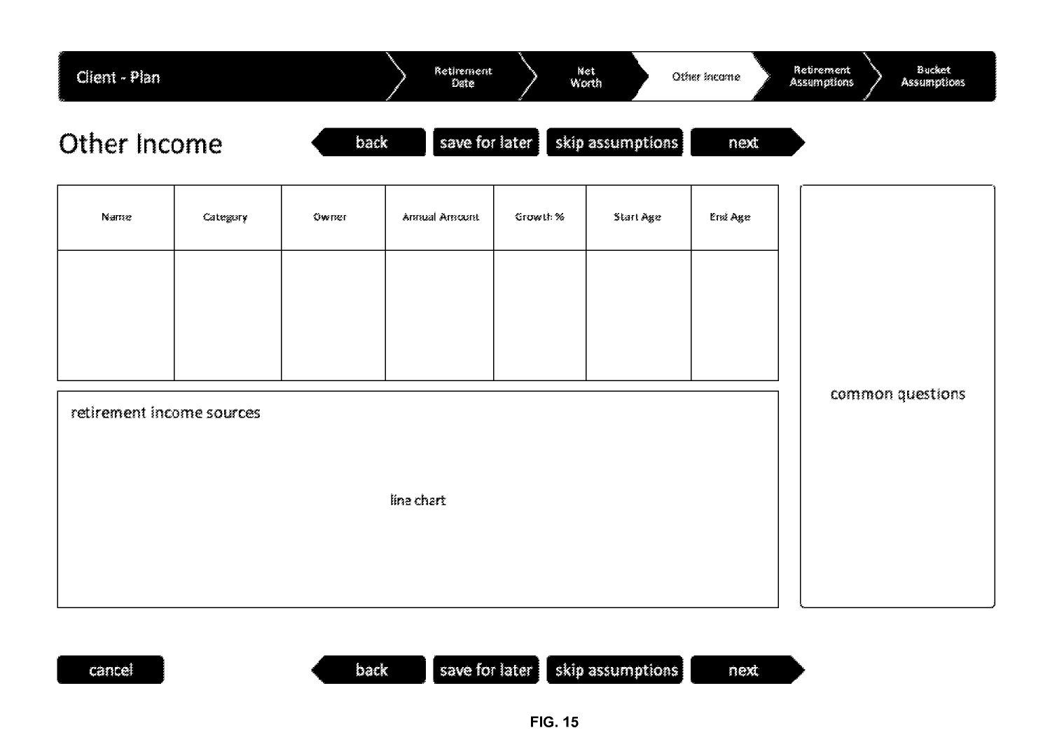

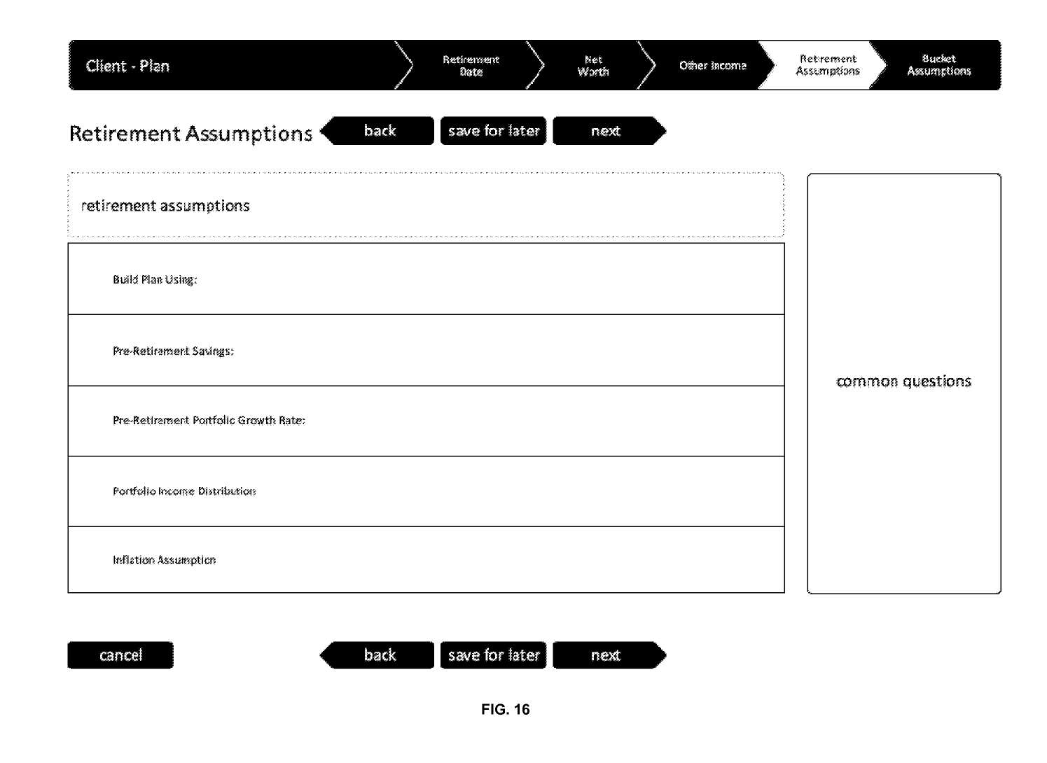

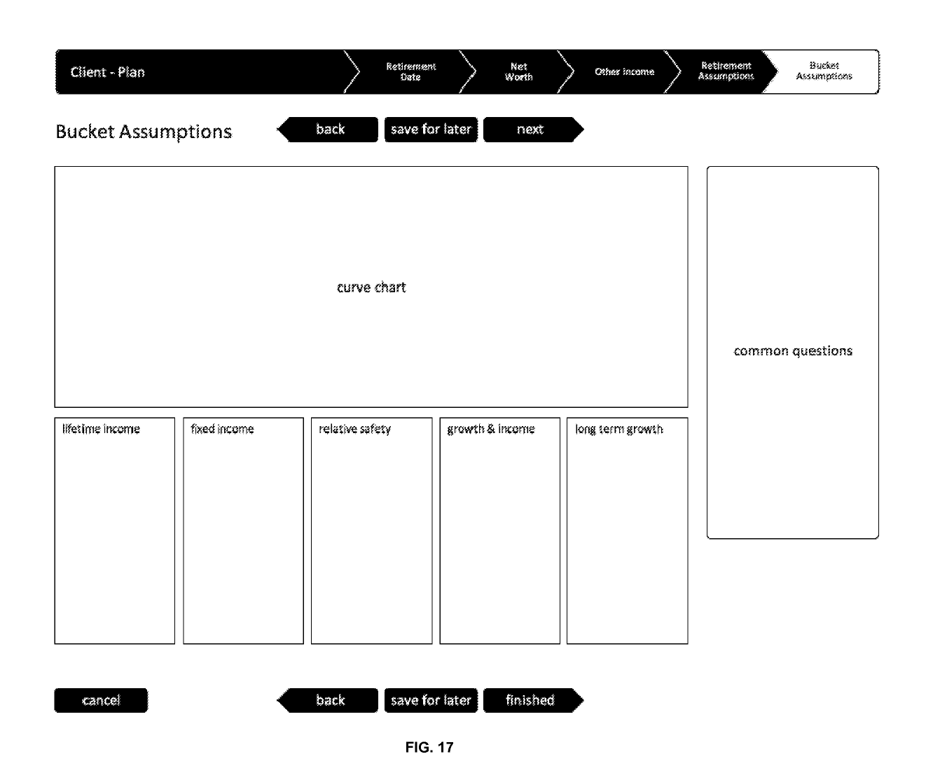

FIG. 13 illustrates a start page for a wizard user interface that can be used to assist a client or financial advisor in creating a wealth management plan for a client according to an embodiment. The start page collects information such as the plan start date, the client's projected retirement date and spouse's projected retirement date. FIG. 14 is a second page of a wizard user interface for creating a wealth management plan for a client according to an embodiment. The second page of the wizard user interface can be used to capture net worth information for the client. The interface includes fields for capturing account information for investment account, bank accounts, and/or other types of accounts that may be held by a client. The second page can be reached by clicking the “next” actionable area/button on the start page or the “back” actionable area/button on the third page of the wizard illustrated in FIG. 15. FIG. 15 is a third page of the wizard user interface for creating a wealth management plan for a client according to an embodiment. The third page of the wizard user interface can be used to capture other income information for the client. The third page can be reached by clicking the “next” actionable area/button on the second page or the “back” actionable area/button on the fourth page of the wizard illustrated in FIG. 16. FIG. 16 is a fourth page of the wizard user interface for creating a wealth management plan for a client according to an embodiment. The fourth page of the wizard user interface can be used to capture retirement assumption information for the client, such as pre-retirement savings amounts, pre-retirement portfolio growth rates, portfolio income distribution, and assumed inflation rate. The fourth page can be reached by clicking the “next” actionable area/button on the third page or the “back” actionable area/button on the fifth page of the wizard illustrated in FIG. 17. FIG. 17 is a fifth page of the wizard user interface for creating a wealth management plan for a client according to an embodiment. The fifth page of the wizard user interface can be used to capture bucket assumption information for the client, such as information related to a lifetime income bucket, a fixed income bucket, a relative safety income bucket, a growth & income bucket, and a long term growth bucket. According to some embodiments, the number of buckets to be included in the wealth management plan can be based at least in part on information entered in the previous wizard user interface screens. While the plan illustrated in FIG. 17 includes five buckets, other plans may include a different number of buckets based on the goals of the individual client. The fifth page can be reached by clicking the “next” actionable area/button on the fourth page of the wizard user interface.

The user interfaces illustrated in FIGS. 13-17 can include a “save” button that allows a user to save the information that has been entered, allowing the user to return to the user interface later and finish entering the client information.

The user interfaces illustrated in FIGS. 9-17 can include a set of links to help topics that explain the information that the collects. According to an embodiment, the help topics can include links to short videos that explain how the screen can be used.

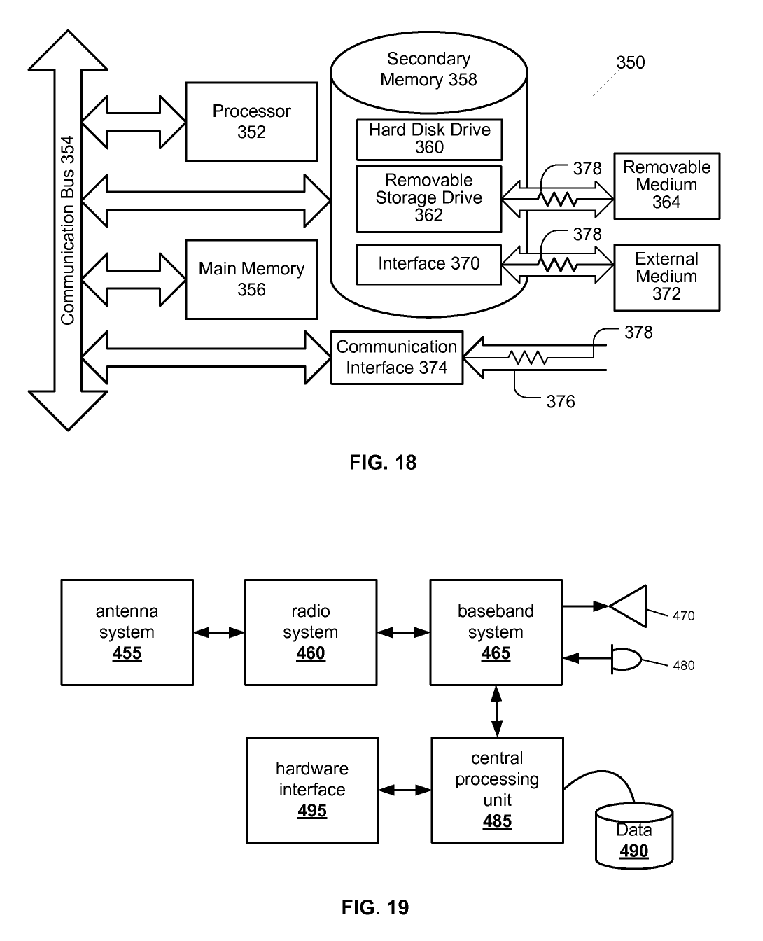

FIG. 18 is a block diagram that illustrates an embodiment of an exemplary computer system 1750 that may be used in connection with various embodiments described herein. For example, the computer system 1750 may be used to implement the client device 170 and the advisor device illustrated in FIG. 1 and can be used to implement the financial planning server 120 illustrated in FIGS. 1 and 2. However, other computer systems and/or architectures may be used, as will be clear to those skilled in the art.

The computer system 1750 preferably includes one or more processors, such as processor 1752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1752.

The processor 1752 is preferably connected to a communication bus 1754. The communication bus 1754 may include a data channel for facilitating information transfer between storage and other peripheral components of the computer system 1750. The communication bus 1754 further may provide a set of signals used for communication with the processor 1752, including a data bus, address bus, and control bus (not shown). The communication bus 1754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 1750 preferably includes a main memory 1756 and may also include a secondary memory 1758. The main memory 1756 provides storage of instructions and data for programs executing on the processor 1752. The main memory 1756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 1758 may optionally include a hard disk drive 1760 and/or a removable storage drive 1762, for example a floppy disk drive, a magnetic tape drive, a compact disc (“CD”) drive, a digital versatile disc (“DVD”) drive, etc. The removable storage drive 1762 reads from and/or writes to a removable storage medium 1764 in a well-known manner. Removable storage medium 1764 may be, for example, a floppy disk, magnetic tape, CD, DVD, etc.

The removable storage medium 1764 is preferably a non-transitory computer readable medium having stored thereon computer executable code (i.e., software) and/or data. The computer software or data stored on the removable storage medium 1764 is read into the computer system 1750 as electrical communication signals 1778.

In alternative embodiments, secondary memory 1758 may include other similar means for allowing computer programs or other data or instructions to be loaded into the computer system 1750. Such means may include, for example, an external storage medium 1772 and an interface 1770. Examples of external storage medium 1772 may include an external hard disk drive or an external optical drive, or and external magneto-optical drive.

Other examples of secondary memory 1758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 1772 and interfaces 1770, which allow software and data to be transferred from the removable storage unit 1772 to the computer system 1750.

Computer system 1750 may also include a communication interface 1774. The communication interface 1774 allows software and data to be transferred between computer system 1750 and external devices (e.g. printers), networks, or information sources. For example, computer software or executable code may be transferred to computer system 1750 from a network server via communication interface 1774. Examples of communication interface 1774 include a modem, a network interface card (“NIC”), a communications port, a PCMCIA slot and card, an infrared interface, and an IEEE 1394 fire-wire, just to name a few.

Communication interface 1774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1774 are generally in the form of electrical communication signals 1778. These signals 1778 are preferably provided to communication interface 1774 via a communication channel 1776. Communication channel 1776 carries signals 1778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 1756 and/or the secondary memory 1758. Computer programs can also be received via communication interface 1774 and stored in the main memory 1756 and/or the secondary memory 1758. Such computer programs, when executed, enable the computer system 1750 to perform the various functions of the present invention as previously described.

In this description, the term “computer readable medium” is used to refer to any non-transitory computer readable storage media used to provide computer executable code (e.g., software and computer programs) to the computer system 1750. Examples of these media include main memory 1756, secondary memory 1758 (including hard disk drive 1760, removable storage medium 1764, and external storage medium 1772), and any peripheral device communicatively coupled with communication interface 1774 (including a network information server or other network device). These computer readable mediums are means for providing executable code, programming instructions, and software to the computer system 1750.

In an embodiment that is implemented using software, the software may be stored on a computer readable medium and loaded into computer system 1750 by way of removable storage drive 1762, interface 1770, or communication interface 1774. In such an embodiment, the software is loaded into the computer system 1750 in the form of electrical communication signals 1778. The software, when executed by the processor 1752, preferably causes the processor 1752 to perform the inventive features and functions previously described herein.

FIG. 19 is a block diagram illustrating an embodiment of an exemplary wireless communication device 1850 that may be used in connection with various embodiments described herein. For example, the wireless communication device 1850 may be used to implement the user devices (client device 170 and advisor device 150) as previously described with respect to FIG. 1. However, other wireless communication devices and/or architectures may also be used, as will be clear to those skilled in the art.

In the illustrated embodiment, wireless communication device 1850 comprises an antenna system 1855, a radio system 1860, a baseband system 1865, a speaker 1870, a microphone 1880, a central processing unit (“CPU”) 1885, a data storage area 1890, and a hardware interface 1895. In the wireless communication device 1850, radio frequency (“RF”) signals are transmitted and received over the air by the antenna system 1855 under the management of the radio system 1860.

In one embodiment, the antenna system 1855 may comprise one or more antennae and one or more multiplexors (not shown) that perform a switching function to provide the antenna system 1855 with transmit and receive signal paths. In the receive path, received RF signals can be coupled from a multiplexor to a low noise amplifier (not shown) that amplifies the received RF signal and sends the amplified signal to the radio system 1860.

In alternative embodiments, the radio system 1860 may comprise one or more radios that are configured to communication over various frequencies. In one embodiment, the radio system 1860 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 560 to the baseband system 1865.

If the received signal contains audio information, then baseband system 1865 decodes the signal and converts it to an analog signal. Then the signal is amplified and sent to the speaker 1870. The baseband system 1865 also receives analog audio signals from the microphone 1880. These analog audio signals are converted to digital signals and encoded by the baseband system 1865. The baseband system 1865 also codes the digital signals for transmission and generates a baseband transmit audio signal that is routed to the modulator portion of the radio system 1860. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1855 where the signal is switched to the antenna port for transmission.

The baseband system 1865 is also communicatively coupled with the central processing unit 1885. The central processing unit 1885 has access to a data storage area 1890. The central processing unit 1885 is preferably configured to execute instructions (i.e., computer programs or software) that can be stored in the data storage area 1890. Computer programs can also be received from the baseband processor 1865 and stored in the data storage area 1890 or executed upon receipt. Such computer programs, when executed, enable the wireless communication device 1850 to perform the various functions of the present invention as previously described. For example, data storage area 1890 may include various software modules (not shown) such as those modules previously described with respect to FIG. 2.

In this description, the term “computer readable medium” is used to refer to any non-transitory media used to provide executable instructions (e.g., software and computer programs) to the wireless communication device 1850 for execution by the central processing unit 1885. Examples of these media include the data storage area 1890, microphone 1880 (via the baseband system 1865), antenna system 1855 (also via the baseband system 1865), and hardware interface 1895. These computer readable mediums are means for providing executable code, programming instructions, and software to the wireless communication device 1850. The executable code, programming instructions, and software, when executed by the central processing unit 1885, preferably cause the central processing unit 1885 to perform the inventive features and functions previously described herein.

The central processing unit 1885 is also preferably configured to receive notifications from the hardware interface 1895 when new devices are detected by the hardware interface. Hardware interface 1895 can be a combination electromechanical detector with controlling software that communicates with the CPU 1885 and interacts with new devices. The hardware interface 1895 may be a firewire port, a USB port, a Bluetooth or infrared wireless unit, or any of a variety of wired or wireless access mechanisms. Examples of hardware that may be linked with the device 1850 include data storage devices, computing devices, headphones, microphones, and the like.

In this description, the term “computer readable medium” is used to refer to any media used to provide executable instructions (e.g., software and computer programs) to the wireless communication device 1850 for execution by the central processing unit 1885. Examples of these media include the data storage area 1890, microphone 1880 (via the baseband system 1865), antenna system 1855 (also via the baseband system 1865), and hardware interface 1895. These computer readable media are means for providing executable code, programming instructions, and software to the wireless communication device 1850. The executable code, programming instructions, and software, when executed by the central processing unit 1885, preferably cause the central processing unit 1885 to perform the inventive features and functions previously described herein.

The central processing unit 1885 is also preferably configured to receive notifications from the hardware interface 1895 when new devices are detected by the hardware interface. Hardware interface 1895 can be a combination electromechanical detector with controlling software that communicates with the CPU 1885 and interacts with new devices. The hardware interface 1895 may be a firewire port, a USB port, a Bluetooth or infrared wireless unit, or any of a variety of wired or wireless access mechanisms. Examples of hardware that may be linked with the device 1850 include data storage devices, computing devices, headphones, microphones, and the like.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A technical system for creating and forecasting the performance of a wealth management plan, the system comprising:
a non-transitory computer readable medium for storing computer executable programmed modules;
a processor communicatively coupled with the non-transitory computer readable medium for executing programmed modules stored therein;
a data collection module stored in the non-transitory computer readable medium and configured to
determine a set of buckets into which investments included in an investment portfolio are to be grouped;
construct a questionnaire comprising a set of questions designed to collect financial information for a user for whom a wealth management plan is to be generated; and
analyze responses to the questions included in the questionnaire to determine whether the user has provided enough information to generate a forecast of the performance of the wealth management plan;
a forecasting module stored in the non-transitory computer readable medium and configured to
calculate a projected performance of investments associated with each bucket; and
generate a wealth management plan report based on the projected performance of the investments associated with each bucket and other answers;
a user interface module stored in the non-transitory computer readable medium and configured to
generate a bucket creation user interface to be displayed to the user on a user device and designed to collect information from the user, said information used by the data collection module to identify the set of buckets;
generate a questionnaire user interface designed to collect user responses to the set of questions selected by the data collection module; and
generate a report interface for displaying wealth management plan report data to the user on a display of the user device.

2. The system of claim 1, further comprising:
a user authentication module stored in the non-transitory computer readable medium and configured to control access to the system by verifying credentials of a user before allowing the user to access content on the system.

3. The system of claim 2, wherein the authentication module is configured to encrypt communications between the system and the user device.

4. The system of claim 1, further comprising:
a communication module stored in the non-transitory computer readable medium and configured to allow a user to send communications to a financial advisor and configured to allow the financial advisor to send communications to the user.

5. The system of claim 4, wherein the report interface includes an implement plan control that, when activated, causes the communication module to send the wealth management plan report to a financial advisor to implement the wealth management plan.

6. The system of claim 3, wherein the communication module is configured to select a financial advisor from a set of financial advisors associated with the system.

7. The system of claim 3, wherein the user interface module is configured to generate a list of financial advisors to be displayed to the user, and wherein the communication module is configured to prompt the user to select a financial advisor from the list of financial advisors if the user has not already selected a financial advisor.

8. The system of claim 1, wherein the user interface module is configured to embed on or more explanatory videos in user interfaces generated by the user interface module, the explanatory videos comprising a short video clip explaining questions or content on the user interface.

9. A computer implemented method for creating and forecasting the performance of a wealth management plan, where one or more processors are programmed to perform steps comprising:
receiving a request to create a wealth management plan from a user device;
identifying a set of buckets to include in the wealth management plan into which investments included in the wealth management plan will be allocated;
generating a questionnaire to collect information from the user;
generating a user interface to display the questionnaire to the user and collect user responses to the questions in the questionnaire;
receiving responses to the questions from the user;
forecasting the performance of investments associated with each buckets in the set of buckets; and
generating a wealth management plan report based on the responses provided by the user.

10. The method of claim 9, wherein identifying the buckets further comprises:
selecting a default set of buckets to be used for creating the wealth management plan from a set of default buckets definitions.

11. The method of claim 9, wherein identifying the buckets further comprises:
selecting a set of buckets based on investment goal information provided by the user.

12. The method of claim 9, wherein identifying the buckets further comprises:
selecting a set of buckets based on investment goal information provided by the user.

13. The method of claim 12, wherein identifying buckets further comprises:
calculating a score based a set of responses to a set of investment goal questions designed to assess the investment goals of the user; and
selecting a set of buckets to be used to implement the wealth management plan from a plurality of predefined buckets configurations based on the score.

14. The method of claim 9, wherein generating the questionnaire further comprises:
accessing a set of questions stored in the data store;
selecting questions related to the types of investments to be included in each of the buckets.

15. The method of claim 9, further comprising:
dynamically updating the contents of the user interface to reflect the responses that the user provides to the questions included in the questionnaire.

16. The method of claim 9, further comprising:
receiving a request from the user to implement the wealth management plan illustrated in the wealth management plan report;
matching the user to a financial advisor; and
sending a the wealth management plan report to the financial advisor.

17. The method of claim 16, wherein matching the user to a financial advisor further comprises:
selecting a financial advisor from a list of candidate financial advisors based on user information provided by the user.

18. The method of claim 17, wherein sending the wealth management plan report to the financial advisor further comprises:
generating a communication that includes contact information for the user and that explains the wealth management plan; and
sending the communication and the wealth management plan report to the user.

19. The method of claim 9, wherein each bucket can have one or more investments associated with the bucket, and each bucket can have a different set of investment goals and timelines associated with the investments associated with the bucket.

20. The method of claim 19, wherein generating wealth management plan report based on the responses provided by the user further comprises:
forecasting the performance of the investments associated with each of the buckets.

21. A computer implemented method for creating and forecasting the performance of a hypothetical wealth management plan, where one or more processors are programmed to perform steps comprising:
receiving a request from a financial advisor to generate a hypothetical wealth management plan for a client, the request including a set of financial information for the client;
identifying a set of buckets to include in the wealth management plan into which investments included in the wealth management plan will be allocated;
generating a hypothetical wealth management plan report for the client based on the financial information provided by the financial advisor; and
sending the hypothetical wealth management plan report to the financial advisor.

22. The method of claim 21, wherein generating the hypothetical wealth management plan report for the client based on financial information further comprises:
forecasting the performance of the investments associated with each of the buckets.

23. The method of claim 22, further comprising:
identifying information required to generate the wealth management plan that is missing from the financial information provided by the financial advisor; and
selecting default information to replace the missing information; and
generating a hypothetical wealth management plan report for the client based on the financial information provided by the financial advisor and the default information.
